(19) United States
(12) Patent Application Publication
(10) Pub. No.: US 2005/0102200 A1
(43) Pub. Date: May 12, 2005

(54) Method and system for selling and purchasing previously owned items

(76) Inventor: Benjamin G. Carnes, Pittsburgh, PA (US)

Correspondence Address: Benjamin G. Carnes, 2021 Larkins Way, Pittsburgh, PA, 15203, US

(21) Appl. No.: 10/985,558

(22) Filed: Nov. 10, 2004

Related U.S. Application Data
(60) Provisional application No. 60/518,102, filed on Nov. 10, 2003.

(51) Int. Cl. G06F 17/60

(52) U.S. Cl. 705/27

(57) ABSTRACT

The invention provides a method that permits a user to log onto an interactive website, which serves as the medium between the buyer user and the seller user. The buyer user is then prompted to enter book location criteria, such as author, title, ISBN or class in order to enable the website to perform a search through its database of used books. If the website finds the particular book that is sought by the buyer user, the buyer user can contact the seller user, via the website, to make and offer on the book. The website provides a method that permits seller users to list used books they wish to sell. The seller user lists a book's location criteria, on the website, such as author, title ISBN or class in order to enable a prospective buyer to easily locate them via the website during a database search.

### PRIORITY

This application hereby claims priority to provisional application No. 60/518,102 filed on Nov. 10, 2003.

### FIELD OF THE INVENTION

The invention relates generally to a method and system of providing a website as a computer readable medium for selling and purchasing previously owned items, and more particularly relates to a method for selling and purchasing previously owned textbooks or other similar items at the collegiate or graduate level through the use of a website published on the Internet and accessible through a network of computers.

### BACKGROUND OF THE INVENTION

College students spend hundreds of dollars on textbooks every semester. Some of these books are not even used by professors during the course of the semester. At the end of the semester, the students take their books back to the bookstore to “sell them back” to the university/college (hereinafter university and college are used interchangeably). The main problem with this transaction is students lose a great deal of money on textbooks, because the bookstores are not willing to buy books back at prices anywhere close to the prices which they sell them.

For instance, a student at a university purchases a calculus book at the bookstore for $125.00 at the beginning of the semester. The student uses the textbook throughout the semester. At the end of the semester, the student feels that the textbook is of no use to him any longer. The student decides to sell the textbook back to the bookstore to at least recover some of the money paid for the book. The bookstore buys it back for $35.00. So in essence it cost the student $90.00 to essentially rent the textbook for one semester. The next semester the bookstore sells the same textbook to another student for $125.00 and the process continues.

The university bookstore, however, does have the advantage over students of knowing what textbooks are being used for the upcoming semesters before they buy the books back from the students. Aka “book knowledge”. The bookstores gladly pay students 25-35% of the book's value when buying them back, because they know that they will be able to resell the book at 100% of its value at the start of the next semester. The bookstores usually do not buy back books that are not being used in the next semester, mainly because they cannot make a profit on those books. A website that provides students with the “book knowledge” information and provides them with a medium to sell and buy used textbooks from and to each other is needed in the art.

Therefore, the present invention overcomes this monetary loss suffered by the students at universities and colleges by providing a medium and method for students to sell and purchase textbooks to and from each other, using a website, rather than selling the textbooks back to the bookstores. The present invention provides students with the same “book knowledge” as the bookstores have regarding which books will be used again in the next semester. Obviously, new books will still have to be purchased at the bookstores.

### SUMMARY OF THE INVENTION

The present invention provides a method and system for using a computer to access an interactive website, hosted on a remote web server and published on a network of computers, to enable students to sell and purchase used textbooks from each other within a university. This invention enables students to receive better monetary returns on their textbooks by avoiding the huge mark up by the university bookstore.

Generally, the method provides the user with a system of using a computer to access an interactive website on which the user logs into his or her account. The website serves as the interactive medium between a buyer user and a seller user and thus will be accessed by buyer users and seller users. The website provides the buyer user a text box in which the user enters a selection of a class of interest or inputs the search criteria for a textbook of interest. Search criteria for a textbook includes author, title, ISBN and class. The website then performs a search through the books listed by seller users in its database. After the search is performed, the website generates an output to the buyer user. The output displays all books, found in the website's database, that meet the buyer users search criteria. Once the buyer user locates the textbook he or she is interested in purchasing, the website provides a means by which the buyer user is able to send an email to the seller of the book to arrange a meeting in order for the sale to take place.

This invention merely provides the medium for buyer users and seller users to interact and communicate with each other regarding the sale of the textbooks over a network of computers. It however, does not provide a medium for the money to change hands between the buyer users and the seller users. The website also provides the seller users with a means by which the seller users can upload information to the website's database about the books being offered for sale. The information entered by the seller user is search criteria such as author, title, ISBN and class. The seller user may also be prompted by the website to enter the price the seller user requests for a certain book.

An object of the present invention is to provide users with greater monetary returns on their textbooks by the use of an interactive website.

Another object of the present invention is to provide users with “book knowledge”, as defined above, much like the college's bookstore.

Yet another object of the present invention is to enable buyer users to locate and contact seller users and for seller users to locate and contact buyer users in order to facilitate the sale of books.

### BRIEF DESCRIPTION OF THE DRAWINGS

FIG. 1 shows a flow diagram of the general arrangement of the present invention.

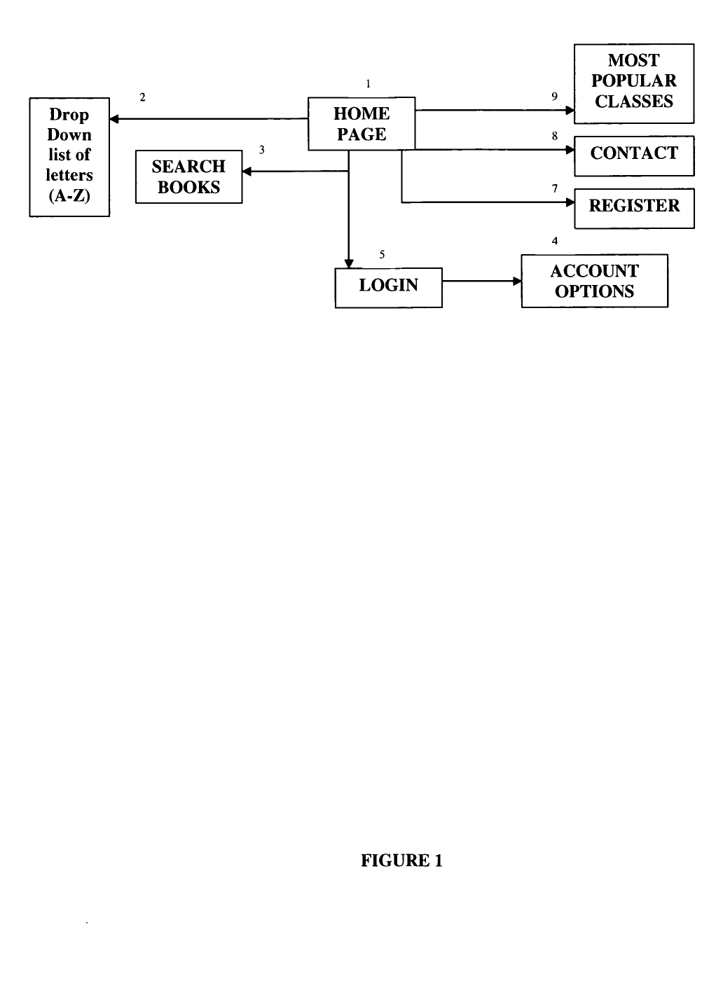

FIG. 2 shows a flow diagram, describing locating books by a particular class.

FIG. 3 shows a flow diagram, describing the search books feature of the present invention.

FIG. 4 shows a flow diagram, describing the member account options of the present invention.

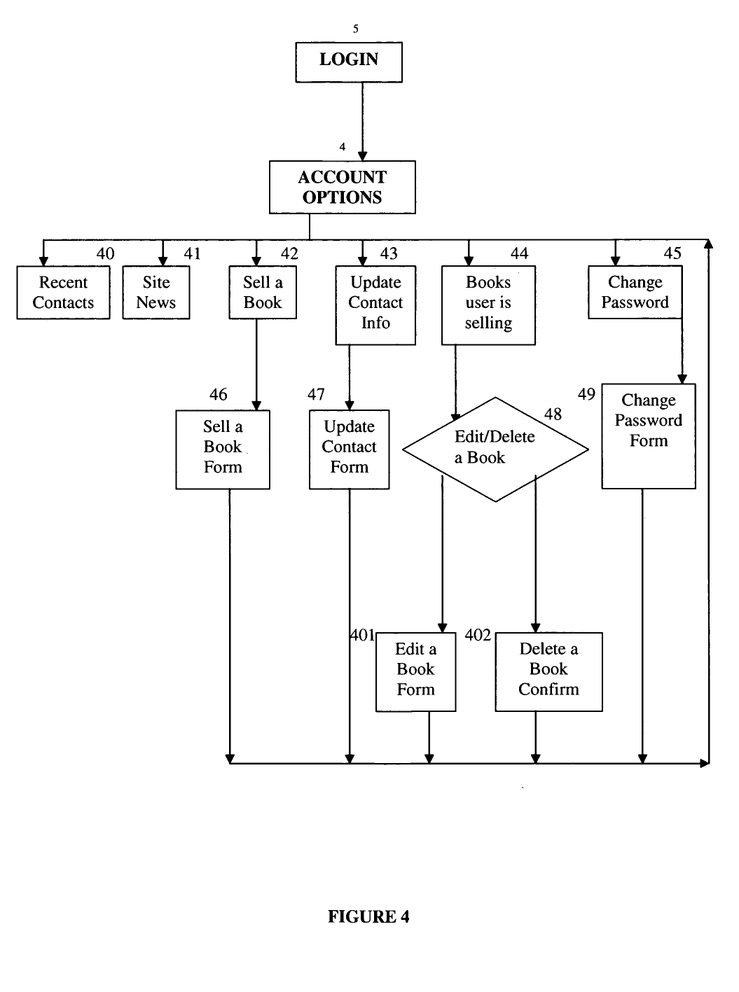

FIG. 5 shows a flow diagram, describing the login process of the present invention.

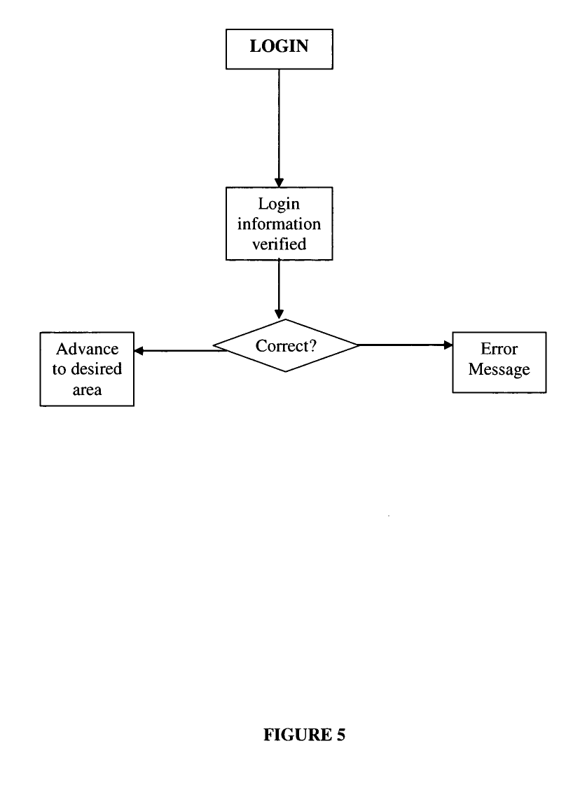

FIG. 6 shows a flow diagram, describing the seller contact process of the present invention.

FIG. 7 shows a flow diagram, describing the registration process of the present invention.

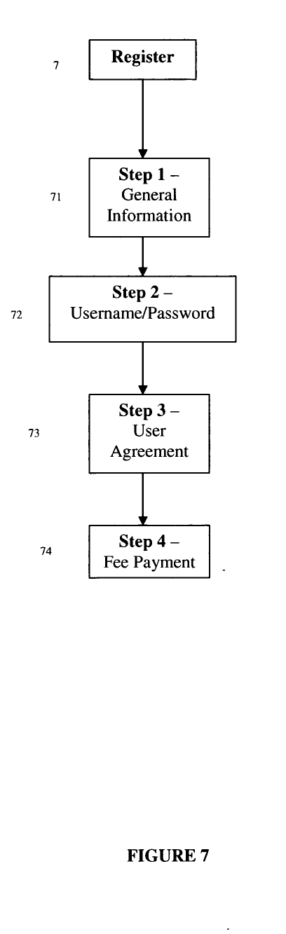

FIG. 8 shows a flow diagram, describing the process by which a user or potential advertiser contacts the website administrators.

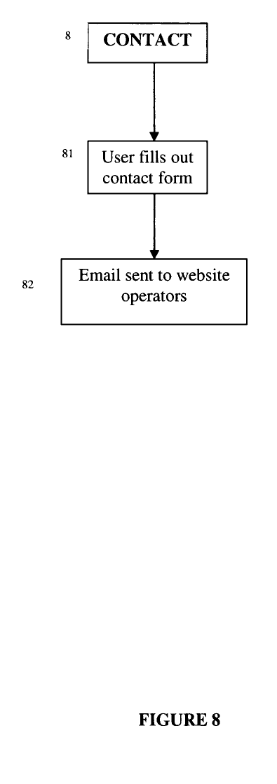

FIG. 9 shows a flow diagram, describing a list of the most popular classes on the website.

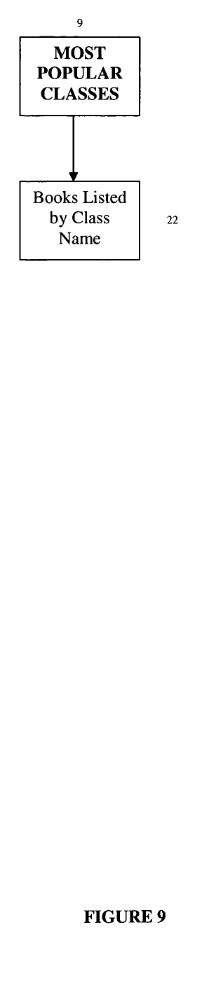

### DETAILED DESCRIPTION OF THE DRAWINGS

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated method, and such further applications of the principles of the invention illustrated herein, as would normally occur to persons skilled in the art to which the invention relates.

This invention is meant to be used on an Internet capable device, such as a desktop computer, a laptop computer, a palm pilot, a cellular phone or any similar device. All further references to a computer will encompass the devices listed above and their equivalents. The computer used will have at least a hard drive, an input device, such as a mouse or keyboard, and an output device such as a monitor or the like. The computer used will be cable of accessing the Internet and its various web pages. Generally, this invention will be accessed using some type of Internet browsing software such as Internet Explorer® or the like.

The website is a computer readable medium that is hosted by a remote web server (server). The web server publishes the website onto the Internet. The Internet is a network of computers that allows users to access other networked computers via web browsing software. The website interacts with a Microsoft SQL Server database or the like. User information, book information, class information or any other necessary information that needs to be stored is stored in a Microsoft SQL Server database or an equivalent. The database connects to the website via ColdFusion or other similar program. All further references to a website will be understood to mean a computer readable medium that is hosted by a remote web server, published on the Internet and accessible through a network of computers.

A user who wishes to sell or purchase certain used textbooks, will log onto the Internet, using a computer, and type in the domain name of the website. Upon entering the home page (1) of the website, the user will be provided with several options. Included in these options and subsequently on every page of the website, are general links to contact information (8) and user registration (7). The contract information (8) area provides a way for users or potential advertisers to contact the website administrators with questions about the website.

The user registration (7) area enables unregistered users to sign up for an account on the website. Each user may be required to pay a fee to become a member of the website and receive its benefits. If a fee is required, it will be a modest monetary amount.

In order to have full use of the website, the user must register for an account. The website provides a link to register for an account (7) on the home page (1). The registration process prompts the user to accomplish four main steps. The first step is to fill out general information (71) about the user including first name, last name, address, and email. The second step is to pick a username and password (72). Every account with the website must have a unique username. If the user attempts to pick a username that is already taken by another user, an error message will be provided to the user by the website. The third step of the registration process is a User Agreement (73). If the user does not agree to the terms and conditions of the User Agreement (73), the website will not allow the user to obtain an account. The fourth step of the registration process is the fee payment (74). Here, the user will pay a fee for using the website, by entering credit card information or other similar means. Again, the fee step is an optional feature of this invention.

Another feature provided on the website home page (1) is a list of the most popular classes (9). The classes with the highest number of books being sold will be displayed on this page. These classes will be displayed from highest to lowest. For example, if Accounting 100 has 350 books for sale, on the website, and that is the highest number of any class, then it would be listed first. If Art 200 has 325 books for sale, and that is the second highest number of books for any class, then it would be listed second. Clicking on the name of the class in this list will take the user to the Books Listed by Class Name (22) page. The class list is stored in the website's database.

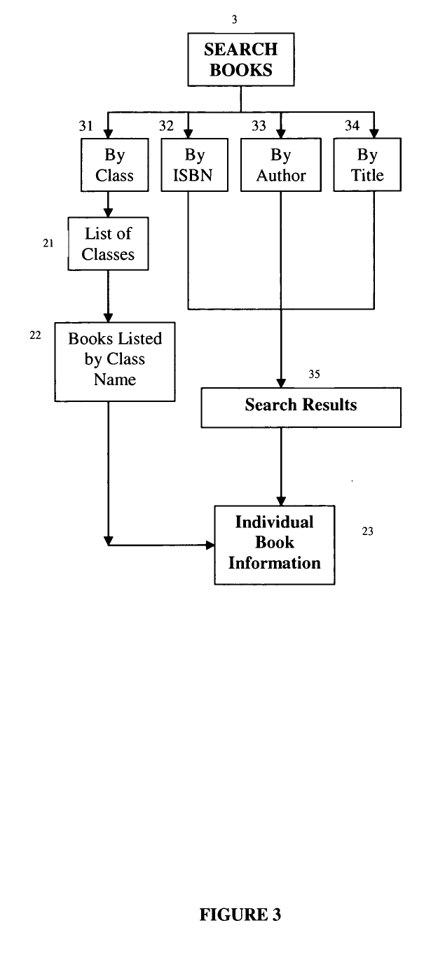

Another feature of the website home page (1) is the search books (3) page as shown in FIG. 3. The search books (3) page will be described in further detail below. Also included on the homepage (1) of the website are a login (5) screen, where registered members login, a lettered dropdown list (2), and a list of the most popular classes (9) with the most books for sale on the website.

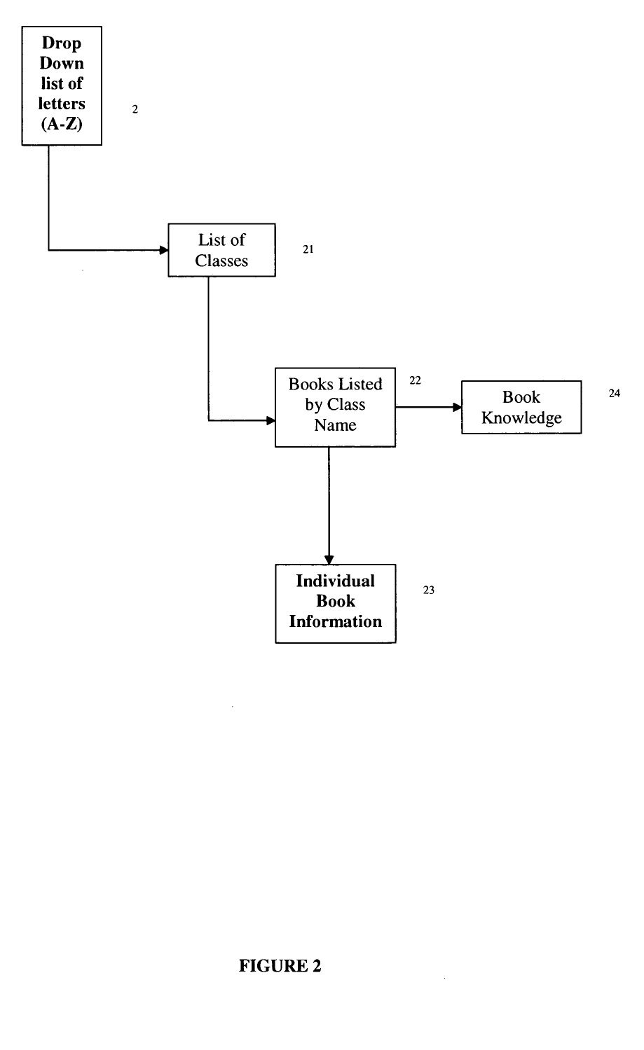

Now referring to FIG. 2, the lettered dropdown list (2) provides the user with the first letters of all or most of the classes that are offered at a university for a given semester. Selecting a letter from this lettered dropdown list (2) will immediately take the user to a list of classes (21) offered at the university starting with that letter. For example, if the user selected “A” from the dropdown list, all classes starting with the letter “A” will appear like; Accounting 1, Accounting 2, Art 100 or Art 250. When a user clicks on one of these class names, the website will direct the user to a list of books for sale for that individual class.

Each individual class that has any books for sale will have a page (22) that displays these books. To display the books for a certain class, the website searches its database. The books listed on this page (22) are those being sold for that class only. Also included on this book display page will be a link to the “book knowledge” (24) chart. This book knowledge (24) chart will provide a list of the books being used for a particular class for the current or upcoming semester. This book knowledge (24) will be provided by the appropriate university department to the website administrator, and will confirm to the user that certain books are indeed being used in a particular class for a certain semester. This book knowledge information is stored in the website's database.

The search books (3) area of the homepage is another feature of this invention. This page allows users to search for books using several different options. These options include searching by class (numbers) (31), ISBN (International Standard Book Number) (32), author (33) and title (34). Every time the user selects a new search option, the homepage will refresh itself to adapt to the different search criteria. To enter search information, the user simply types author, title, class or ISBN of the book into a search text box (not shown).

For example, if a buyer user is searching by author (33) and cannot seem to find the book he or she is trying to locate, the buyer user can simply click on the title (34) box. When the buyer user does this, the website will reset itself to adapt to search by title (34) instead of by author (33). This example would be the same if the buyer user switched from class (31) to ISBN (32), or ISBN (33) to title (34) or any other variation.

When the buyer user selects searching using class (31), he or she will achieve a result very similar to using the lettered drop down list (21). Clicking on a class name will take the user to the page listing all books available for the class name (22) located in the website's database.

When searching by title (34), author (33), or ISBN (32), the user will be directed to a search results page (35) with specific results based on what words or numbers were entered by the buyer user into the search box. This search results (35) page lists all books, in that website's database, that meet the search requirements entered into the search text box. If no books are available for the search requirements, the website will provide the buyer user with a message of that result.

Clicking on the book title in the search results (35) box will take the buyer user to the book information page (23). Clicking on the class name will take the buyer user to the books listed by class name (22) page, which lists all other books that are being sold for that class.

The book information (23) page displays the pertinent information for the book that is being sold. Listed are the title, author, ISBN, class, section, price, seller, and a description of the book entered by the seller user. All this information is stored in the website's database.

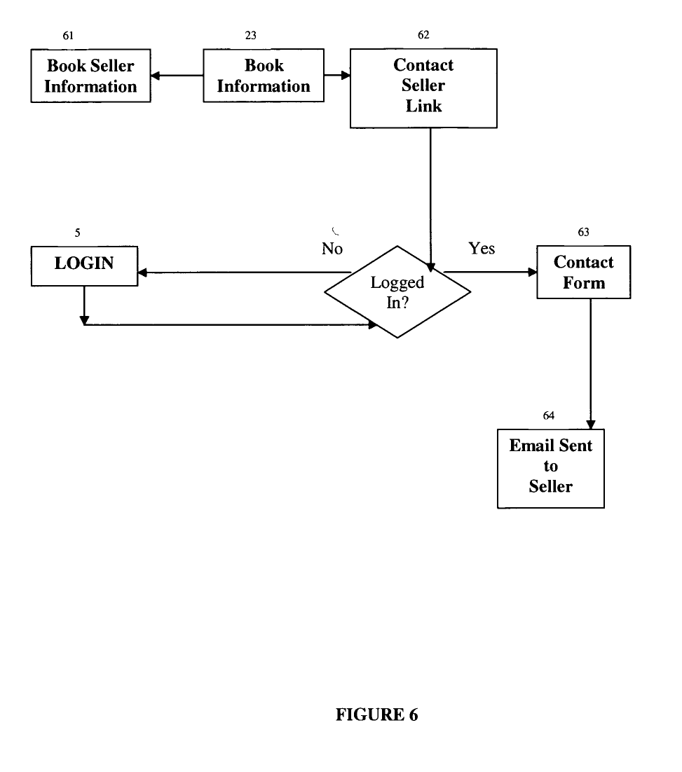

Now referring to FIG. 6, if the buyer user is currently logged into his/her account, they will see a link (62) to contact the seller user of the book. If the buyer user is not logged into the website, they will be prompted to login (5) to their account, and then they again will be provided with the link (62) to contact the seller user of the book. As described above, to set up an account the user needs to go to the register (7) page of the website, fill in the general information (71), pick a username and password (72), read and agree to the terms and conditions of the user agreement (73) and optionally pay a modest fee (74).

Once the buyer user is logged in and clicks the link (62) to contact the seller user of the book, the website directs the buyer user to the contact form page (63).

This seller user information (61) page displays certain information about the seller of the book. This information is again stored in the website's database. Included on this page are the various books the user is currently selling and links to those books. Also listed here is the number of books the user has sold on the website. A rating for the seller user can also be provided on this page to let the purchaser know how reliable the seller user has been in the past with other buyers.

The contact form (63) page is another important aspect of the website. This page (63) provides the medium where any registered buyer user can contact a seller user about a textbook being offered for sale. The potential buyer user can fill out the contact seller (63) form that will automatically send an email to the seller user, via the <cfmail> functionality of ColdFusion® or some other similar software. This email will contain the potential buyers email address and a message from the potential buyer. For example, the content of the email may look as shown below:

The following buyer user has contacted you on domainname.com for book titled: “Introduction to Accounting”

User: johndoe

Email: johndoe@hotmail.com

Message:

Hello, I am interested in buying “Introduction to Accounting” from you. Please respond to me if it is still for sale.

Obviously, “domainname” will be the actual domain name of the website.

From the point when buyer/seller contact is initiated, the book selling process is handled on a personal, buyer to seller level. The invention provides a method of using a website that is merely a medium for the seller user and buyer user to contact each other, not a medium for the actual sales to take place. All prices and arrangements for book transfers are agreed upon between the buyer user and the seller user. If the seller user is uninterested in the potential buyer user's request, the seller user can simply not reply to the email they receive and the potential buyer will never have any personal information about the seller user.

If a user does not register with the website and optionally pay the modest fee, he or she will have only limited access to the website. Mainly, the buyer user will not be able to email the seller user and the seller user will not be able to post books for sale. Once a user logs into the website, ColdFusion® (or some other equivalent software) establishes a session variable that will keep the user logged into the website. A session variable essentially keeps track of the user's “session” on the website. A session variable is kept until that session ends. The user is continually logged into the website, and all session variables are kept until one of two things happen. These two actions that log a user out of the website and delete their session variables are:

1. The user selects the “logout” link on each page of the website, clearing the session variable; or

2. the user is inactive on the website for a specific period of time, usually from 15 minutes to two hours, again clearing the session variable.

In order to log into the website, the user must have a username and password, which they select in the registration (7) process. Each user has a unique username and can change their password at any specific time using the account options (4) page.

The website enables any user to log into the website from two areas. The first area is the homepage (1), and the second is the book information (23) page. Once a user has logged into the system, by entering his username and password, the website provides a link to account options (4) on the homepage. Clicking on this link takes-the user into their specific account options (4).

There are several options a user can pursue from the account options (4) page:

Recent Contacts (40)—This area displays a message to the seller user that a potential buyer user, or several potential buyer users, has/have contacted them about a book they are currently selling.

Site News (41)—This area provides any current news happening at the website, including any new features of the website or offers for users. Other university campus specific news may be displayed here as well.

Sell a Book (42)—This is the area that provides seller users with the ability to post and sell books. Once a book is added in this screen, it is displayed publicly on the website. This step is further defined below.

Update Contact Info (43)—In this area, the website provides the user with the ability to update certain contact info including address, city, zip code, state, or email. The website does not allow the user's first and last name, and username, to be changed by the user after the registration process.

Books User is Selling (44)—In this area, the website provides the seller user with the ability to edit or delete any books that they are currently selling. When editing, the seller user can change certain information about the book including its description or price. When the seller user removes a book it is permanently removed from the website's memory.

Change password (45)—In this area, the website allows the user to change their password for the website.

Sell of book Form (46)—In this area, the website allows the seller user to add a book they would like to sell to the website by filling out this form.

The seller users will be required by the website to input author, title, ISBN, their user name, the amount requested for the book, condition of the book and any additional comments about the book.

Update Contact Form (47)—In this area, the website allows the user to update certain contact information, including address, city, zip, state, or email address.

Edit/Delete a Book (48)—In this area, the website provides the seller user with the ability to delete a book they are selling from the website, or change the information for that book.

To post a book for sale on the website a seller user would get on the Internet, using an Internet capable computer, and log into the website using a web browser. The seller user would then click on the account options (4) link on the homepage (1) of the website. Once inside the account options (4) page, the website provides a user with a sell a book (42) option. This link will take the seller user to a sell a book form (46). The sell a book form (46), requires the seller user to input all the information explained above. After the seller user fills in all the required information, the seller user clicks some type of “ok” or “submit” link on the website, to post the book for sale. All posted book information is stored in the website's database.

Throughout the description the applicant has referred to seller users and buyer users. It is the intention of the present invention to provide a website in which a single person can be both a seller user and a buyer user. Most likely, this will be the case, in that students through this invention can sell used books from previous courses and buy used books for upcoming courses.

Advertising space is strategically placed in the design of the homepage and throughout the entire website. The advertisement's main purpose is to provide cash flow to the website, to continue day to day operations, and to improve the website. Another purpose of the advertisements is to lower the registration costs to the users.

An advertiser or user trying to contact the website operators will first type in the domain name of the website. They will then click on the contact (8) link on the homepage (1) of the website. The advertiser or user then will be taken to a contact form (81). This form (81) basically prompts the user or advertiser for their name and question, or other similar information. Once the user or advertiser is finished inputting all the required information, the website will send an email (82) to the website operators. The website operators will then respond accordingly.

An apparatus that performs the method described above is also within the scope of this invention. Mainly, an apparatus is provided that comprises an interactive website stored on a remote web server, published onto a network of computers that allows buyer users and seller users to communicate with each other. The website includes a database that stores information as described above.

It should be understood that while the invention has been disclosed and described with reference to specific embodiments, there are variations and modifications which may be introduced that will nevertheless come within the scope and spirit of the invention as defined by the appended claims.

1. A method and medium for selling and purchasing previously owned items, the method comprising:
using remote web server;
hosting an interactive website from said remote web server;
publishing said interactive website onto a network of computers using said remote web server;
said interactive website permits users to perform the functions of:
logging onto said interactive website;
searching for a particular item using at least one of author, title, ISBN, or class information;
contacting a seller user of said book; and
offering said seller user a monetary amount for a purchase of said book.
